(19) United States
(12) Patent Application Publication
(10) Pub. No.: US 2026/0268335 A1
(43) Pub. Date: Sep. 10, 2026

(54) GENERATION OF REPLACEMENT ENTITY DATA TO REPLACE A COMPUTING ENTITY

(71) Applicant: International Business Machines Corporation, Armonk, NY (US)

(72) Inventors: Su Liu, Austin, TX (US); Karen Beale, Mitchellville, MD (US); Glen Corneau, Round Rock, TX (US); MICHAEL DAVIS, Chesterfield, MO (US); Richard Anthony LaFrance, Grosse Ile, MI (US); FEDERICO NEUMAYER, Fort Lauderdale, FL (US); Paul Stephen Gray, Buda, TX (US); Timothy Spencer, Whitefish Bay, IL (US); Bob Collins, Frisco, TX (US)

(21) Appl. No.: 19/073,251

(22) Filed: Mar. 7, 2025

(51) Int. Cl. G06Q 30/012; G06F 11/30

(52) U.S. Cl. CPC G06Q 30/012; G06F 11/3055

(57) ABSTRACT

Generation of replacement entity data to replace a computing entity includes receiving image data associated with a computing entity. Further, sensor data associated with the computing entity is obtained. The sensor data is obtained from one or more sensors associated with the computing entity. A first artificial intelligence (AI) model is applied to the image data and the sensor data. Entity data associated with the computing entity is determined based on the applying of the first AI model to the image data and the sensor data. Replacement entity data is generated based on the entity data. The replacement entity data is associated with a replacement computing entity to replace the computing entity. Further, the replacement entity data is outputted.

### BACKGROUND

The disclosure relates to computing entities and more particularly, to the replacement of the computing entities.

In large enterprise server environments, asset management is vital for maintaining operational efficiency. Management tools enable organizations to track and manage hardware assets across data storage facilities, providing detailed part numbers for various components. Support portals allow users to input server models to access lists of compatible parts, while features like Machine Type Model (MTM) offer specific part associations for streamlined identification. Additionally, document databases, including searchable resources, enable identification of components, ensuring that organizations can manage the hardware assets and simplify timely replacements when mandatory.

### SUMMARY

In various embodiments of the disclosure, a computer-implemented method for generation of replacement entity data to replace a computing entity is described. The computer-implemented method includes receiving, by a computer, image data associated with a computing entity. The computer-implemented method further includes obtaining, by the computer, sensor data associated with the computing entity. The sensor data is obtained from one or more sensors associated with the computing entity. The computer-implemented method further includes applying, by the computer, a first artificial intelligence (AI) model to the image data and the sensor data. The computer-implemented method further includes determining, by the computer, entity data associated with the computing entity based on the applying of the first AI model to the image data and the sensor data. The computer-implemented method further includes generating, by the computer, replacement entity data based on the entity data. The replacement entity data is associated with a replacement computing entity to replace the computing entity. The computer-implemented method further includes outputting, by the computer, the replacement entity data.

In various embodiments of the disclosure, a computer system for generation of replacement entity data to replace a computing entity is described. The computer system includes a processor set, a computer-readable storage media, and program instructions that are stored on the one or more computer-readable storage media. The program instructions are executable by the processor set to cause the processor set to receive image data associated with a computing entity. The program instructions further cause the processor set to obtain sensor data associated with the computing entity. The sensor data is obtained from one or more sensors associated with the computing entity. The program instructions further cause the processor set to generate embedded data based on the image data and the sensor data. The program instructions further cause the processor set to apply a first artificial intelligence (AI) model to the embedded data. The program instructions further cause the processor set to determine entity data associated with the computing entity based on the application of the first AI model to the embedded data. The program instructions further cause the processor set to generate replacement entity data based on the entity data. The replacement entity data is associated with a replacement computing entity to replace the computing entity. The program instructions further cause the processor set to output the replacement entity data.

In various embodiments of the disclosure, a computer program product for generation of replacement entity data to replace a computing entity is described.

Additional technical features and benefits are realized through the process of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for generation of replacement entity data to replace a computing entity, in accordance with an embodiment of the disclosure;

FIG. 2 is a diagram that illustrates an environment for the generation of the replacement entity data to replace the computing entity, in accordance with an embodiment of the disclosure;

FIG. 3 is a block diagram that illustrates one or more operations for the generation of the replacement entity data to replace the computing entity, in accordance with an embodiment of the disclosure;

FIG. 4 is a block diagram that illustrates one or more operations for transmission of replacement order data associated with a replacement computing entity, in accordance with an embodiment of the disclosure;

FIG. 5A is a diagram that illustrates a first exemplary User Interface (UI) for the generation of the replacement entity data to replace the computing entity, in accordance with an embodiment of the disclosure;

FIG. 5B is a diagram that illustrates a second exemplary User Interface (UI) for the generation of the replacement entity data to replace the computing entity, in accordance with an embodiment of the disclosure;

FIG. 5C is a diagram that illustrates a third exemplary User Interface (UI) for the generation of the replacement entity data to replace the computing entity, in accordance with an embodiment of the disclosure;

FIG. 5D is a diagram that illustrates a fourth exemplary User Interface (UI) for the generation of the replacement entity data to replace the computing entity, in accordance with an embodiment of the disclosure;

FIG. 6 is a diagram that illustrates a flowchart for the reception of the image data based on a transmission of instructions data, in accordance with an embodiment of the disclosure;

FIG. 7 illustrates a flowchart of an exemplary method for the generation of the replacement entity data to replace the computing entity, in accordance with an embodiment of the disclosure; and

FIG. 8 illustrates a flowchart of an exemplary method for the generation of the replacement entity data to replace the computing entity, in accordance with an embodiment of the disclosure.

### DETAILED DESCRIPTION

Data storage facilities are specialized environments designed to efficiently house and manage large volumes of data using advanced computing systems and infrastructure. The data storage facilities typically feature rows of servers, storage devices, and networking equipment, maintained in a controlled environment to ensure most favorable performance and reliability. With robust cooling systems, redundant power supplies, and advanced security measures in place, the data storage facilities are decisive for supporting various applications, including cloud computing, data backup, and disaster recovery. The data storage facilities play a vital role in enabling organizations to store, process, and access data effectively, ensuring business continuity and meeting increasing demand for data-driven services in today's digital landscape.

However, when hardware failures occur within the servers associated with the data storage facilities, traditional methods for addressing such issues often involve manual diagnostics and component replacement. Traditional methods for identifying compatible parts in the servers often involve manual processes that require significant time and effort. Technicians typically cross-reference product manuals, consult online databases, or contact original equipment manufacturers (OEMs) to determine the correct part number for replacements of failed hardware. This approach can be labor-intensive and may necessitate multiple steps to ensure accuracy, especially when dealing with a wide array of components across different server models and series.

Additional challenges associated with these traditional methods further include the complexity of identifying compatible parts arising from the vast number of components in enterprise servers, many of which are incompatible across various models. This complexity can lead to errors in part identification, particularly when similar parts exist. Additionally, the identification process is often time-consuming and prone to mistakes, resulting in operational delays and increased costs if incorrect parts are ordered. Finally, the reliance on human expertise for part identification increases the risk of errors, especially in environments with more staff turnover or uneven distribution of knowledge. To overcome the abovementioned problems within the traditional processes, a system for a generation of replacement entity data to replace a computing entity is disclosed. The computing entity may be a mechanical or a computing part in any type of machine or/and appliance present within data storage facilities.

The disclosed system addresses the challenges of identifying compatible replacement parts for computing entities by leveraging artificial intelligence models. The disclosed system receives image data from a user device associated with the technician working in the data storage facility, and sensor data associated with the computing entity from one or more sensors associated with the computing entity. Further, the disclosed system applies a first AI model to analyze the image data and the sensor data. This process enables the disclosed system to accurately determine entity data associated with the computing entity, enabling the generation of replacement entity data for a compatible replacement computing entity. An output of this process streamlines the identification and ordering of replacement parts, significantly reducing the time and effort compared to traditional methods.

Further, the disclosed system enhances accuracy in part identification, which further minimizes the risk of errors associated with manual processes. Further, by integrating the image data and the sensor data, the disclosed system provides a comprehensive understanding of the computing entity to be replaced, ensuring that the correct replacement part, e.g., the replacement computing entity, is identified. Additionally, an automated character of the disclosed system reduces reliance on human expertise, mitigating the impact of staff turnover and knowledge gaps. Furthermore, the ability of the disclosed system to generate the replacement entity data in real-time improves operational efficiency, leading to reduced downtime and lower costs associated with incorrect part orders. The disclosed system represents a significant advancement in the management of the computing entity replacements within data storage facilities.

In various embodiments of the disclosure, a computer-implemented method for generation of replacement entity data to replace a computing entity is described. The computer-implemented method includes receiving, by a computer, image data associated with a computing entity. The computer-implemented method further includes obtaining, by the computer, sensor data associated with the computing entity. The sensor data is obtained from one or more sensors associated with the computing entity. The computer-implemented method further includes applying, by the computer, a first artificial intelligence (AI) model to the image data and the sensor data. The computer-implemented method further includes determining, by the computer, entity data associated with the computing entity based on the applying of the first AI model to the image data and the sensor data. The computer-implemented method further includes generating, by the computer, replacement entity data based on the entity data. The replacement entity data is associated with a replacement computing entity to replace the computing entity. The computer-implemented method further includes outputting, by the computer, the replacement entity data.

In various embodiments of the disclosure, the computer-implemented method further includes embedding, by the computer, the image data with the sensor data. The computer-implemented method further includes generating, by the computer, embedded data based on the embedding. The computer-implemented method further includes applying, by the computer, the first AI model to the embedded data.

In various embodiments of the disclosure, the computer-implemented method further includes applying, by the computer, a second AI model to the replacement entity data. The computer-implemented method further includes generating, by the computer, replacement request data associated with a replacement request for the computing entity. The replacement request data is generated based on the applying of the second AI model to the replacement entity data. The computer-implemented method further includes outputting, by the computer, the replacement request data.

In various embodiments of the disclosure, the computer-implemented method further includes transmitting, by the computer, the replacement request data to a user device associated with a user. The computer-implemented method further includes receiving, by the computer, validation data associated with the replacement request. The validation data is received based on the transmitting of the replacement request data. The computer-implemented method further includes validating, by the computer, the replacement request based on the validation data. The computer-implemented method further includes transmitting, by the computer, replacement order data to an ordering server based on the validating of the replacement request.

In various embodiments of the disclosure, the computer-implemented method further includes generating, by the computer, instructions data for a wearable device. The wearable device is associated with the user. The computer-implemented method further includes transmitting, by the computer, the instructions data to the wearable device. The computer-implemented method further includes receiving, by the computer, the image data based on the transmitting of the instructions data.

In various embodiments of the disclosure, the computer-implemented method further includes receiving, by the computer, criterion data indicating a set of selection criterion for a selection of the replacement computing entity. The computer-implemented method further includes generating, by the computer, the replacement entity data based on the criterion data.

In various embodiments of the disclosure, the sensor data indicates contextual hardware information associated with at least one of the computing entity, or a device including the computing entity.

In various embodiments of the disclosure, the sensor data includes at least one of time data associated with the obtaining of the sensor data, client data associated with a client using the computing entity, anomaly data for an anomaly associated with the computing entity, device data associated with the device including the computing entity, or status data associated with the device.

In various embodiments of the disclosure, the replacement entity data includes at least one of an entity name associated with the replacement computing entity, an entity number associated with the replacement computing entity, a price associated with the replacement computing entity, availability status data associated with the replacement computing entity, or storage facility data associated with one or more storage facilities storing the replacement computing entity.

In various embodiments of the disclosure, the entity data includes at least one of a serial number associated with the computing entity, a unit number associated with the computing entity, a name associated with the computing entity, location data associated with the computing entity, an entity type associated with the computing entity, or an entity number associated with the computing entity.

In various embodiments of the disclosure, the computer-implemented method further includes validating, by the computer, the replacement entity data based on the image data. The computer-implemented method further includes outputting, by the computer, the replacement entity data based on the validating of the replacement entity data.

In various embodiments of the disclosure, the computing entity corresponds to a data center component.

In various embodiments of the disclosure, a computer system for generation of replacement entity data to replace a computing entity is described. The computer system includes a processor set, a computer-readable storage media, and program instructions that are stored on the one or more computer-readable storage media. The program instructions are executable by the processor set to cause the processor set to receive image data associated with a computing entity. The program instructions further cause the processor set to obtain sensor data associated with the computing entity. The sensor data is obtained from one or more sensors associated with the computing entity. The program instructions further cause the processor set to generate embedded data based on the image data and the sensor data. The program instructions further cause the processor set to apply a first artificial intelligence (AI) model to the embedded data. The program instructions further cause the processor set to determine entity data associated with the computing entity based on the application of the first AI model to the embedded data. The program instructions further cause the processor set to generate replacement entity data based on the entity data. The replacement entity data is associated with a replacement computing entity to replace the computing entity. The program instructions further cause the processor set to output the replacement entity data.

In various embodiments of the disclosure, the program instructions further cause the processor set to apply a second AI model to the replacement entity data. The program instructions further cause the processor set to generate replacement request data associated with a replacement request for the computing entity. The replacement request data is generated based on the application of the second AI model to the replacement entity data. The program instructions further cause the processor set to output the replacement request data.

In various embodiments of the disclosure, the program instructions further cause the processor set to transmit the replacement request data to a user device associated with a user. The program instructions further cause the processor set to receive validation data associated with the replacement request. The validation data is received based on the transmission of the replacement request data. The program instructions further cause the processor set to validate the replacement request based on the validation data. The program instructions further cause the processor set to transmit replacement order data to an ordering server based on the validation of the replacement request.

In various embodiments of the disclosure, the program instructions further cause the processor set to generate instructions data for a wearable device. The wearable device is associated with the user. The program instructions further cause the processor set to transmit the instructions data to the wearable device. The program instructions further cause the processor set to receive the image data based on the transmission of the instructions data.

In various embodiments of the disclosure, the program instructions further cause the processor set to receive criterion data that indicates a set of selection criterion for a selection of the replacement computing entity. The program instructions further cause the processor set to generate the replacement entity data based on the criterion data.

In various embodiments of the disclosure, the sensor data indicates contextual hardware information associated with at least one of the computing entity, or a device including the computing entity.

In various embodiments of the disclosure, the program instructions further cause the processor set to validate the replacement entity data based on the image data. The program instructions further cause the processor set to output the replacement entity data based on the validation of the replacement entity data.

In various embodiments of the disclosure, a computer program product for generation of replacement entity data to replace a computing entity is described. The computer program product includes a computer-readable storage media having program instructions stored on the computer-readable storage media to perform operations. The operations include receiving image data associated with the computing entity. The operations further include obtaining sensor data associated with the computing entity. The sensor data is obtained from one or more sensors associated with the computing entity. The operations further include applying an artificial intelligence (AI) model to the image data and the sensor data. The operations further include determining entity data associated with the computing entity based on the applying of the AI model to the image data and the sensor data. The operations further include generating replacement entity data based on the entity data. The replacement entity data is associated with a replacement computing entity to replace the computing entity. The operations further include outputting the replacement entity data.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

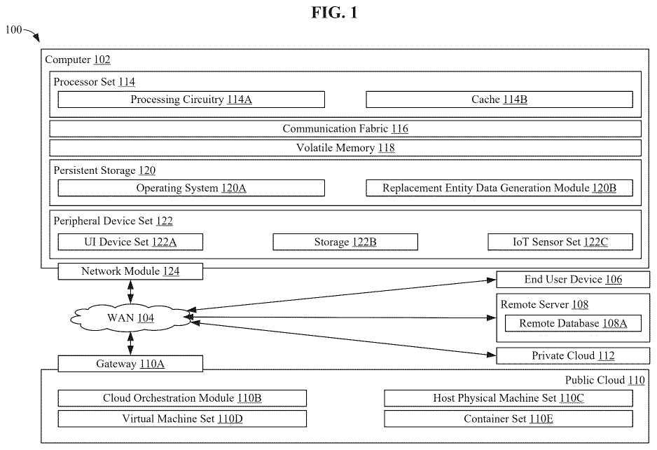

FIG. 1 is a diagram that illustrates a computing environment for generation of replacement entity data to replace a computing entity, in accordance with an embodiment of the disclosure. With reference to FIG. 1, there is shown a computing environment 100 that contains an example of an environment for execution of at least some of the computer code/module involved in performing the methods, such as a replacement entity data generation module 120B. In addition to the replacement entity data generation module 120B, computing environment 100 includes, for example, a computer 102, a wide area network (WAN) 104, an end-user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the replacement entity data generation module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or any different form of a computer or a mobile device now known or to be developed in the future that is configured to running a program, accessing a network or querying a database, such as a remote database 108A. As is well understood in the art of computer technology, and depending upon the technology, the performance of a computer-implemented method may be distributed among multiple computers and/or between multiple locations. Additionally, in this presentation of the computing environment 100, detailed discussion is focused on a single computer, specifically the computer 102, to keep the presentation as simple as possible. The computer 102 may be located in a cloud, even though it is not shown in a cloud in FIG. 1. Additionally, the computer 102 doesn't have to be in a cloud except to any extent as may be affirmatively indicated.

The processor set 114 includes one or more computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby affect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and the storage media discussed below. The program instructions, and associated data, are accessed by the processor set 114 to control and direct the performance of the methods. In computing environment 100, at least some of the instructions for performing the methods may be stored in the dynamic modification of the replacement entity data generation module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Different types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not vital unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the replacement entity data generation module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is mandatory to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer, and an alternate sensor may be a motion detector.

The network module 124 is the collection of computer software, hardware, and firmware that allows computer 102 to communicate with different computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In an embodiment of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) configured for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize the resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

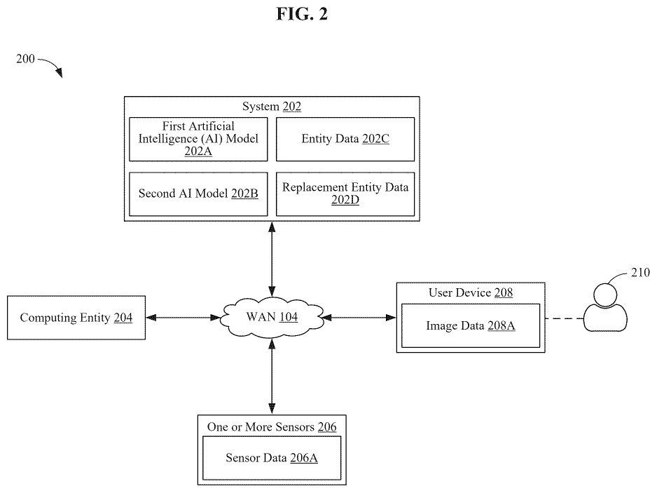

FIG. 2 is a diagram that illustrates an environment for the generation of replacement entity data to replace a computing entity, in accordance with an embodiment of the disclosure. FIG. 2 is explained in conjunction with elements from FIG. 1. With reference to FIG. 2, there is shown a diagram of a network environment 200. The network environment 200 includes a system 202, a computing entity 204, one or more sensors 206, and a user device 208. The system 202 further includes a first Artificial Intelligence (AI) model 202A and a second AI model 202B. The system 202 may also store the entity data 202C and replacement entity data 202D. The user device 208 further stores image data 208A associated with the computing entity 204. The one or more sensors 206 may transmit sensor data 206A associated with the computing entity 204. The user device 208 is associated with a user 210. The network environment 200 further includes the WAN 104 of FIG. 1. In an embodiment of the disclosure, the system 202 may be an exemplary embodiment of the computer 102 in FIG. 1.

The system 202 may include suitable logic, circuitry, interfaces, and/or code that may be configured to receive the image data 208A associated with the computing entity 204. The system 202 is further configured to obtain the sensor data 206A associated with the computing entity 204. The sensor data 206A is obtained from the one or more sensors 206 associated with the computing entity 204. The system 202 is further configured to apply the first AI model 202A to the image data 208A and the sensor data 206A. The system 202 is further configured to determine the entity data 202C associated with the computing entity 204 based on the application of the first AI model 202A to the image data 208A and the sensor data 206A. The system 202 is further configured to generate the replacement entity data 202D based on the entity data 202C. The replacement entity data 202D is associated with a replacement computing entity to replace the computing entity 204. The system 202 is further configured to output the replacement entity data 202D. In an embodiment, the system 202 may be implemented on a computing device, a server, a computer workstation, or a mainframe machine.

In an embodiment, the first AI model 202A and the second AI model 202B may correspond to an Artificial intelligence (AI) foundational model, such as, but not limited to, a Large Language Model (LLM), Generative Pre-trained Transformer (GPT) models, or other large-scale AI models. The Artificial intelligence (AI) foundational model may be specifically designed to analyze and interpret complex data inputs, such as the image data 208A and the sensor data 206A associated with the computing entity 204. In various embodiments, the first AI model 202A and the second AI model 202B may be independent AI models operating separately. In various embodiments, the first AI model 202A and the second AI model 202B may be implemented as a single AI model.

The LLMs utilize deep learning processes to process vast amounts of information, enabling the first AI model 202A, and the second AI model 202B to understand context, identify patterns, and generate coherent outputs. The first AI model 202A applies algorithms to extract relevant features from the provided image data 208A and the sensor data 206A, enabling the accurate determination of the entity data 202C related to the computing entity 204. By leveraging the capabilities of the LLMs, the first AI model 202A enhances the ability of the system 202 to generate the replacement entity data 202D, ultimately streamlining the process of identifying compatible parts and improving operational efficiency within data storage facilities.

In an exemplary embodiment, the training of the first AI model 202A may include a process that utilizes a dataset that includes images and sensor data from various computing entities. The dataset is created to include a wide range of hardware components, ensuring that the first AI model 202A can learn to recognize and differentiate between different computing entities effectively. During the training phase, the first AI model 202A may employ a supervised, unsupervised, or reinforcement learning process, where it is exposed to labeled examples that associate specific image and sensor data with the entity data 202C corresponding thereto. Through iterative training, the first AI model 202A adjusts its parameters to minimize prediction errors, enhancing the ability of the first AI model 202A to extract relevant features and determine the entity data 202C. By way of example, and not by limitation, the first AI model 202A may undergo fine-tuning to optimize its performance to generate the entity data 202C and improve the overall efficiency of the part identification in data storage facilities.

In an embodiment, the computing entity 204 may include suitable logic, circuitry, interfaces, and/or code that may correspond to a hardware component. By way of example, and not by limitation, the computing entity 204 may be a part of an equipment present within the data storage facilities such as, but not limited to, a data center. In an exemplary embodiment, the computing entity 204 may be, but is not limited to, Hard Disk Drives (HDDs), Solid State Drives (SSDs), routers, switches, and firewalls. The data center is a centralized facility that houses computer systems, servers, and networking equipment to store, manage, and process large volumes of data. It provides vital services such as power, cooling, and security to ensure the continuous operation of Information Technology (IT) infrastructure. The data center supports various applications, including cloud computing, web hosting, and enterprise data management. In an embodiment, the computer system associated with the data center may correspond to the system 202. In an alternate embodiment, the computer system associated with the data center may be different from the system 202.

In an embodiment, the replacement computing entity refers to a new hardware component that may substitute the computing entity 204, ensuring continuity in performance and functionality. In an embodiment, the replacement computing entity may be of the same specifications as of the computing entity 204, allowing for seamless integration within the server associated with the computing entity 204. In an alternate embodiment, the replacement computing entity may be of upgraded configurations, providing enhanced capabilities or improved performance metrics if a newer version is available.

The user device 208 may include suitable logic, circuitry, interfaces, and/or code that may be configured to capture the image data 208A. By way of example, and not by limitation, the image data 208A may correspond to one or more images of the computing entity 204.

In an embodiment, the user device 208 may include a display screen. In an embodiment, the user 210 may correspond to a stand-alone user or an organization associated with the user device 208. Examples of the user device 208 may include, but are not limited to, a computing device, a server, a computer work-station, a smartphone, a cellular phone, a mobile phone, a mainframe machine, a gaming device, a consumer electronic (CE) device, a head-mounted device, a projection-based system, and/or any device with computer vision display capabilities.

In operation, for the generation of the replacement entity data 202D to replace the computing entity 204, the system 202 is configured to receive the image data 208A associated with the computing entity 204. In an embodiment, the image data 208A is received from the user device 208 associated with the user 210. In an exemplary embodiment, the image data 208A corresponds to the one or more images of the computing entity 204 that has malfunctioned. In a scenario, the user 210 (a technician or a data center engineer) is working in the data storage facility (say the data center). The data center includes a plurality of servers. Each server of the plurality of servers includes a plurality of hardware components. In case any hardware component of the plurality of components malfunctions, it needs to be replaced with the new hardware component. In this scenario, the malfunctioned hardware component corresponds to the computing entity 204. Further, the new hardware component corresponds to the replacement computing entity. In an embodiment, the user 210 is notified if the computing entity 204 malfunctions. Upon receiving the notification, the user 210 captures the image of the computing entity 204 using the user device 208. Further, the system 202 receives the image data 208A including the image of the computing entity 204 from the user device 208.

Further, upon receiving the image data 208A, the system 202 is configured to obtain the sensor data 206A associated with the computing entity 204. In an embodiment, the sensor data 206A is received from the one or more sensors 206 associated with the computing entity 204. By way of example, and not by limitation, the one or more sensors 206 corresponds to Internet of Things (IoT) sensors that may be integrated with each hardware component of the plurality of hardware components in the data center. The one or more sensors 206 may be, but are not limited to, a Radio Frequency Identification (RFID) Sensor, a temperature sensor, a humidity sensor, a vibration sensor, a power consumption sensor, and optical sensors.

In an embodiment, the RFID sensors may be integrated with the computing entity 204 to detect serial numbers associated with the computing entity 204. Further, the temperature sensor may monitor temperature of the computing entity 204 to ensure that the computing entity 204 operates within a temperature threshold value. The temperature sensor may prevent overheating of the computing entity 204 by providing real-time temperature data. The system 202 may trigger an alert on a wearable device associated with the user 210 to notify the user 210 in case the temperature of the computing entity 204 goes beyond the temperature threshold value. Further, the humidity sensor may measure moisture levels within a proximity of the computing entity 204. The humidity sensor may prevent the computing entity 204 from getting damaged due to moisture levels within the proximity of the computing entity 204 going beyond the moisture threshold value. The system 202 may trigger the alert on the wearable device associated with the user 210 to notify the user 210 in case the moisture within the proximity of the computing entity 204 goes beyond the moisture threshold value.

In an embodiment, upon receiving the image data 208A and obtaining the sensor data 206A, the system 202 is configured to apply the first AI model 202A to the image data 208A and the sensor data 206A. In an embodiment, the system 202 is configured to embed the image data 208A and the sensor data 206A to generate embedded data. Upon generating the embedded data, the system 202 is configured to apply the first AI model 202A on the embedded data. To embed the image data 208A and the sensor data 206A for application of the first AI model 202A, the system 202 may convert the image data 208A into vector representations, known as embeddings, which enable analysis and pattern recognition. Additionally, the system 202 integrates the sensor data 206A by aligning the sensor data 206A with the image embeddings, allowing the first AI model 202A to process and learn from the image data 208A and the sensor data 206A simultaneously. The system 202 receives the image data 208A, obtains the sensor data 206A, and pre-processes the image data 208A and the sensor data 206A to ensure compatibility and quality for embedding. By way of example, and not by limitation, the system 202 performs transformation processes such as resizing and normalization on the image data 208A to convert the image data 208A into a numerical format that the first AI model 202A can interpret. Parallelly, the system 202 formats the sensor data 206A to align with the image embeddings, generating the embedded data. Once the embedded data is generated, the first AI model 202A is applied to the embedded data.

By way of example, and not by limitation, the image data 208A corresponds to the image of the malfunctioned hardware component (e.g., the computing entity 204). The computing entity 204 may correspond to a Solid State Drive (SSD). The system 202 receives the image data 208A. Further, the system 202 obtains the sensor data 206A associated with the malfunctioned SSD. In an embodiment, the sensor data 206A may indicate contextual hardware information associated with the computing entity 204. In an alternate embodiment, the sensor data 206A may indicate the contextual hardware information associated with the computing entity 204 and a device (say the server associated with the malfunctioned SSD) comprising the computing entity 204.

Further, the first AI model 202A is applied to the image data 208A and the sensor data 206A. Upon the application of the first AI model 202A, the system 202 determines the entity data 202C associated with the computing entity 204. In an embodiment, the entity data 202C includes information that may correspond to, but is not limited to, a serial number associated with the computing entity 204, a unit number associated with the computing entity 204, a name associated with the computing entity 204, location data associated with the computing entity 204, an entity type associated with the computing entity 204, or an entity number associated with the computing entity 204.

In an exemplary embodiment, the serial number may correspond to a unique identifier assigned to the computing entity 204. The system 202 may be configured to utilize the serial number associated with the computing entity for tracking and warranty purposes. Further, the name may correspond to a product name of the computing entity 204, providing a recognizable reference for the user 210. Further, the location data may correspond to information detailing the physical location of the computing entity 204 within the data storage facility or network, enabling easy access, replacements, and maintenance of the computing entity 204. Further, the entity type may correspond to a classification that identifies a category of the computing entity 204, such as the SSD, a Hard Disk Drive (HDD), or various hardware components, helping to distinguish between different hardware components. Further, the entity number may correspond to an identifier that may be used to reference the computing entity 204 within inventory or management systems, ensuring accurate tracking and reporting. By way of example, and not by limitation, the system 202 determines that the computing entity 204 corresponds to the SSD by applying the first AI model 202A on the image data 208A and the sensor data 206A.

Further, upon the determination of the entity data 202C, the system 202 is configured to generate the replacement entity data 202D based on the determined entity data 202C. The replacement entity data 202D is associated with the replacement computing entity that may be used to replace the computing entity 204. In an embodiment, the replacement entity data 202D includes at least one of an entity name associated with the replacement computing entity, an entity number associated with the replacement computing entity, a price associated with the replacement computing entity, an availability status data associated with the replacement computing entity, or a storage facility data associated with one or more storage facilities storing the replacement computing entity.

In an embodiment, the entity name identifies the product name of the replacement computing entity, ensuring clarity and recognition for the user 210. Further, the entity number may correspond to an identifier (model number) for the replacement computing entity, enabling accurate tracking and management within the data storage facilities. The price may be indicative of a cost associated with acquiring the replacement computing entity. The availability status data indicates whether the replacement computing entity is currently in stock at one or more storage facilities. Further, the storage facility data indicates a location of one or more storage facilities that may have the replacement computing entity in stock.

In an embodiment, upon the generation of the replacement entity data 202D, the system 202 is further configured to output the replacement entity data 202D. In an exemplary embodiment, the system 202 is configured to output the replacement entity data 202D on the user device 208.

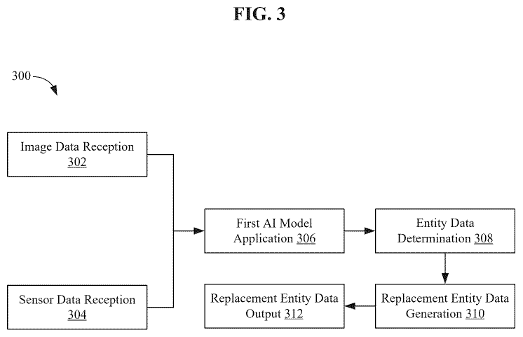

FIG. 3 is a block diagram 300 that illustrates one or more operations for the generation of the replacement entity data 202D to replace the computing entity 204, in accordance with an embodiment of the disclosure. FIG. 3 is explained in conjunction with elements from FIG. 1, and FIG. 2

At 302, an image data reception operation is executed. In the image data reception operation, the system 202 is configured to receive the image data 208A associated with the computing entity 204. In an example, the computing entity 204 corresponds to a data center component, such as an SSD. By way of example, and not by limitation, the SSD is associated with a server present within a data center. The SSD is a type of data storage device that uses flash memory to store data, providing faster access times and improved performance compared to traditional Hard Disk Drives (HDDs). The malfunctioned SSD may impact performance and data accessibility of the server within the data storage facility.

At 304, a sensor data reception operation is executed. In the sensor data reception operation, the system 202 is configured to obtain the sensor data 206A associated with the computing entity 204. The sensor data 206A is obtained from one or more sensors 206 associated with the computing entity 204. In an embodiment, the system 202 may parallelly obtain the sensor data 206A from the one or more sensors 206 at 302B.

By way of example, and not by limitation, the one or more sensors 206 includes the temperature sensor. The system 202 is configured to obtain temperature data from the temperature sensor associated with the computing entity 204. The temperature data indicates the temperature of the SSD. Similarly, each sensor of the one or more sensors 206 executes desired operations associated with the corresponding sensor. The sensor data 206A associated with the computing entity 204 (the malfunctioned SSD) further includes anomaly data.

By way of example, and not by limitation, the anomaly data indicates that the temperature of the computing entity 204 (the SSD) is beyond the temperature threshold value. For example, an operating temperature associated with the computing entity 204 may correspond to 30 degrees Celsius. The temperature threshold value associated with the SSD corresponds to 35 Degrees Celsius. Further, the temperature data obtained by the system 202 indicates that the temperature of the SSD has risen to 45 degrees Celsius. Thus, the anomaly data obtained by the system 202 indicates that there is an anomaly within the computing entity 204. An example of the sensor data 206A associated with the malfunctioned computing entity 204 is provided below:

TABLE 1
Sensor data received from one or more sensors
associated with computing entity

| Field | Value |
|---|---|
| Time Data | 12:01 PM |
| Client Data | 892-7414000 |
| Unit | Unit 4 |
| Rack | Rack 2 |
| Lab | Data Recovery Lab |
| Building | Main Data Center |
| Address | 1234 Tech Lane |
| Device Data | Server -XYZ Gen 10 |
| Hardware Status | Failed |
| Software Status | N.A |
| Serial Number | SN987654321 |
| Temperature (° C.) | 45 |
| Humidity (%) | 30 |
| Power Consumption (W) | 350 |
| Network Status | Disconnected |
| Anomaly Data | Temperature is beyond |
| | temperature threshold value |

Further, upon the execution of the sensor data reception operation, the control may pass to 306.

At 306, a first AI model application operation is executed. In the first AI model application operation, the system 202 is configured to apply the first AI model 202A to image data 208A and sensor data 206A. Details associated with the first AI model 202A are provided in conjunction with, for example, FIG. 1. By way of example, and not by limitation, the system 202 receives the image data from the user device 208. The image data may indicate one or more images of the computing entity 204, e.g., SSD, that has malfunctioned. In an embodiment, the system 202 embeds the image data 208A with the obtained sensor data 206A to generate the embedded data. The details about the embedded data are provided in conjunction with, for example, FIG. 1. Further, the system 202 is configured to apply the first AI model 202A to the embedded data.

Further, upon the application of the first AI model 202A to embedded data, the control may pass to 308.

At 308, an entity data determination operation is executed. In the entity data determination operation, the system 202 is configured to determine the entity data 202C associated with the computing entity 204 based on the application of the first AI model 202A to the image data 208A and the sensor data 206A. In an alternate embodiment, the system 202 is configured to determine the entity data 202C by applying the first AI model 202A on the embedded data.

By way of example, and not by limitation, by applying the first AI model 202A on the embedded data, the system 202 determines that the computing entity corresponds to the SSD. An example of the entity data 202C associated with the computing entity 204 (the malfunctioned SSD) is provided below:

TABLE 2
Entity data associated with computing entity

| Field | Value |
|---|---|
| Unit | Unit 4 |
| Rack | Rack 2 |
| Lab | Data Recovery Lab |
| Building | Main Data Center |
| Address | 1234 Tech Lane |
| Serial Number | SN987654321 |
| Name | Solid State Drive |
| Entity Type | Storage Media |
| Entity Number | XYZ 990 Pro |

In an exemplary embodiment, the table 2 describes the determined entity data 202C associated with the malfunctioned SSD. The determined entity data 202C associated with the malfunctioned SSD is organized in a structured format, for example, a table. The table may have two columns a “Field” column and a “Value” column. In a first cell of the field column, an entry Unit corresponds to “Unit 4” in the value column, indicating the specific location of the SSD within the server. The next entry in the field column corresponds to “Rack” paired with “Rack 2” in the value column, further narrowing down the location.

Further, the field entry “Lab” is associated with the value “Data Recovery Lab” indicating that this area is dedicated to recovering data from malfunctioning or failed storage devices. This contextual information is vital for understanding the operational environment of the SSD and the potential urgency of addressing the malfunction. The field labeled as “Building” indicates “Main Data Center” providing a geographical context, while the “Address” field, “1234 Tech Lane” indicates a complete physical address.

Further, the field “Serial Number” corresponds to the value “SN987654321” indicating a unique identifier for the SSD, which is vital for warranty claims, tracking, inventory management, and generation of the replacement entity data 202D. The field labeled “Name” identifies the component as a “Solid State Drive,” indicating the type of storage media in question. The “Entity Type” field categorizes the SSD as “Storage Media”. Further, the field “Entity Number” is paired with the Value “XYZ 990 Pro” providing a model number that can be used to reference the specific version of the SSD, ensuring that any replacement or repair actions are accurately aligned with the correct specifications. Further, upon the generation of the entity data 202C, the control may pass to 310.

At 310, a replacement entity data generation operation is executed. In the replacement entity data generation operation, the system 202 is configured to generate the replacement entity data 202D based on the entity data 202C. The replacement entity data 202D is associated with a replacement computing entity to replace the computing entity 204.

An example of the replacement entity data 202D associated with the replacement computing entity (a new SSD) is provided below:

TABLE 3
Replacement entity data associated
with replacement computing entity

| Field | Value |
|---|---|
| Entity Name | SSD |
| Entity Number | 12345 |
| Price | $200 |
| Availability Status Data | Available |
| Storage Facility Data | 1234, ABC City, DEF Country |

In an exemplary embodiment, the system 202 is configured to generate the replacement entity data 202D by utilizing a backend database that may include extensive information about various computing entities. The backend database may serve as a centralized repository, that includes vital information such as manufacturer information, pricing, and real-time availability of the replacement computing entity. When the system 202 identifies the malfunction in the computing entity 204, the system 202 initiates the replacement entity data generation operation to ensure that the correct replacement part is sourced and provided to the user 210.

The system 202 utilizes the entity data 202C associated with the computing entity 204 including vital identifiers such as the serial number of the computing entity and the entity number of the computing entity 204, and specifications associated with the computing entity 204 to identify requirements for the replacement computing entity. By analyzing the entity data 202C, the system 202 determines the type of replacement needed, ensuring that it aligns with the specifications of the original component (the computing entity).

By way of example, and not by limitation, to identify the replacement computing entity, the system 202 queries the backend database to gather relevant information about potential replacement computing entities. This includes identifying SSDs that match the specifications of the malfunctioned SSD, such as form factor, capacity, and performance characteristics. In an embodiment, the backend database may be structured to allow for efficient searches, enabling the system 202 to identify suitable replacement options based on the criteria derived from the entity data.

In an exemplary embodiment, the system 202 is configured to receive criterion data from the user 210. The criterion data may indicate a set of selection criteria for a selection of the replacement computing entity. For instance, the user 210 may specify that the replacement SSD should be from the same manufacturer as the malfunctioned SSD to ensure compatibility and reliability. This criterion is vital, as it helps maintain consistency in performance across the hardware components used within the server. The user 210 may further specify additional criteria, such as the requirement for the replacement SSD to have the same capacity as the malfunctioned SSD, ensuring that the new component (the replacement computing entity) can handle the same data load and operational demands as the computing entity 204.

Upon receiving the criterion data, the system 202 processes the criterion data and queries the backend database to identify potential replacement SSDs that meet the set of selection criterion. Further, the system 202 filters the available SSDs, narrowing down the options to those that match the set of selection criterion. For example, if the original SSD (the computing entity 204) was a 1 Terabyte (TB) model from manufacturer “A”, then the system 202 will search for 1 TB SSDs produced by manufacturer “A”, ensuring that the replacement part aligns with the specifications.

Once the system 202 has identified suitable replacement computing entities from the database, the system 202 generates the replacement entity data 202D based on the criterion data. The replacement entity data 202D may be organized into a structured format such as the table, including fields such as “Entity Name”, “Entity Number”, “Price”, “Availability Status Data”, and “Storage Facility Data”. By incorporating the criterion data, the generated replacement entity data 202D reflects the specific needs of the user 210, ensuring that the recommended SSD not only meets the technical requirements but also aligns with user preferences.

In an embodiment, the system 202 accesses manufacturer information stored in the backend database, which provides information about the brand and model of the replacement SSD. This information is vital for ensuring compatibility and reliability, as it allows the system 202 to recommend products from reputable manufacturers that meet the substantial standards. By cross-referencing the manufacturer details with the entity data 202C, the system 202 can further refine the selection of potential replacement computing entity.

Further, the backend database contains pricing details for each potential replacement computing entity. The system 202 retrieves the price information for the identified SSDs, allowing it to present users with accurate cost estimates. Further, the system 202 is configured to check the availability status of the replacement SSDs in real-time. The backend database may provide up-to-date information on stock levels and availability of the potential replacement computing entities across various storage facilities. This ensures that user 210 is only presented with options that are currently in stock, minimizing a risk of delay in obtaining the vital replacement computing entity.

Further, once the system 202 has gathered relevant information, the system 202 may compile the replacement entity data 202D into the structured format such as the table. Each field associated with the table is populated with the corresponding values retrieved from the backend database, creating a comprehensive profile of the replacement computing entity.

As described in Table 3, the “Entity Name” field is populated with “SSD,” indicating the name of the replacement computing entity. The “Entity Number” is assigned a unique identifier, such as “12345” which helps in tracking and referencing the specific model of the SSD (the replacement computing entity). The “Price” field indicates the cost of the replacement SSD, set at “$200”. The “Availability Status Data” field is marked as “Available,” confirming that the replacement SSD can be bought without delay. Further, the “Storage Facility Data” field includes the location details, such as “1234, ABC City, DEF Country,” indicating where the replacement SSD can be bought.

Further, upon the generation of the replacement entity data 202D, the system 202 is configured to out the replacement entity data 202D at 312.

At 312, a replacement entity data output operation is executed. In the replacement entity data operation, the system 202 is configured to output the replacement entity data 202D. By way of example, and not by limitation, the system 202 is configured to output the generated replacement entity data 202D on the user device 208 associated with the user 210.

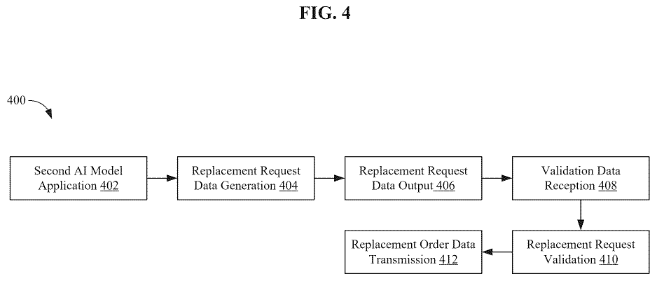

FIG. 4 is a block diagram 400 that illustrates one or more operations for transmission of replacement order data associated with a replacement computing entity, in accordance with an embodiment of the disclosure. FIG. 4 is explained in conjunction with elements from FIG. 1, FIG. 2, and FIG. 3. With reference to FIG. 4, the operations may start at 402.

At 402, a second AI model application operation is executed. In the second AI model application operation, the system 202 is configured to apply a second AI model to the replacement entity data 202D. In an exemplary embodiment, once the replacement entity data 202D is outputted on the user device 208, the user 210 is presented with a list of potential replacement computing entities that meet the set of selection criterion for the selection of the replacement computing entity. As described in FIG. 3, the replacement entity data 202D includes vital details, such as the entity name associated with the replacement computing entity, the entity number associated with the replacement computing entity, the price associated with the replacement computing entity, the availability status data associated with the replacement computing entity, and the storage facility data associated with the replacement computing entity. The user 210 can review the outputted replacement entity data 202D and select the most relevant replacement computing entity based on their specific needs and preferences.

Further, upon the selection of the most relevant replacement computing entity by the user 210, the system 202 initiates the process of generating an order form designed for ordering of the selected replacement computing entity. The system 202 may be configured to utilize the second AI model 202B trained to automatically populate the order form with the relevant details extracted from the replacement entity data 202D. The second AI model 202B may ensure that vital fields are accurately filled in, streamlining the ordering process and reducing the likelihood of errors that can occur with manual data entry. Further, by eliminating the manual data entry, the system 202 reduces the time for ordering the replacement computing entity.

At 404, a replacement request data generation operation is executed. In the replacement request data generation operation, the system 202 is configured to generate the replacement request data associated with a replacement request for the computing entity 204. The replacement request data is generated based on the application of the second AI model to the replacement entity data 202D.

By way of example, and not by limitation, the system 202 may retrieve the information associated with the selected replacement computing entity, such as entity name and entity number. For example, if the user 210 selects the SSD with the entity name “SSD” and entity number “12345,” the system 202 may utilize the applied second AI model 202B to automatically input these details into corresponding fields of the replacement request data. In an embodiment, the replacement request data may correspond to the order form. Additionally, the price field will be populated with the value of “$200” and the availability status data will indicate that the SSD is “Available”. Further, once the replacement request data associated with the replacement request is generated, the system 202 is configured to output the replacement request data at 406.

At 406, a replacement request data output operation is executed. In the replacement request data output operation, the system 202 is configured to output the replacement request data. By way of example, and not by limitation, once the order form is fully populated with the relevant data, the system 202 outputs the order form to the user 210. In an embodiment, the replacement request data (the populated order form) may be rendered on the user device 208 associated with the user 210. In an alternate embodiment, to output the replacement request data on the user device 208, the system 202 is configured to transmit the replacement request data to the user device 208 associated with the user 210. Further, upon the outputting of the replacement request data, the control may pass to 408.

At 408, a validation data reception operation is executed. In the validation data reception operation, the system 202 is configured to receive validation data associated with the replacement request. The validation data is received based on the transmission of the replacement request data. By way of example, and not by limitation, the system 202 is configured to receive the validation data from the user device 208 associated with the user 210. For example, once the user 210 analyzes the replacement request data transmitted on the user device 208, the user 210 may validate the replacement request. The replacement request corresponds to a request to place an order for the replacement computing entity. Based on the analysis of the replacement request data, the user 210 may provide as input, the validation data. In an embodiment, the validation data may correspond to an allowance of the replacement request. In an alternate embodiment, the validation data may correspond to a denial of the replacement request. Further, upon the successful reception of the validation data, the control may pass to 410.

At 410, a replacement request validation operation is executed. In the replacement request validation operation, the system 202 is configured to validate the replacement request based on the validation data. In a scenario, if the validation data received by the system 202 corresponds to the denial of the replacement request, then the system 202 is configured to again execute the replacement request data generation operation. In a scenario, if the validation data received by the system 202 corresponds to the allowance of the replacement request, then the system 202 is configured to transmit the replacement order data to an ordering server at 412.

At 412, a replacement order data transmission operation is executed. In the replacement order data transmission operation, the system 202 is configured to transmit replacement order data to an ordering server based on the validation of the replacement request. By way of example, and not by limitation, once the replacement order data is transmitted to the ordering server, the ordering server processes the replacement request. This includes verifying the availability of the selected SSD, confirming the pricing, and initiating the procurement process. The ordering server may also communicate with inventory management systems to ensure that the SSD is in stock and can be shipped to the user on time. By transmitting the validated order data, the system 202 enables a seamless transition from the user 210 selection to the actual ordering process, thereby enhancing operational efficiency.

Additionally, the transmission of the replacement order data to the ordering server allows for real-time tracking and updates regarding the order status. The ordering server can provide feedback to the system 202, which can then relay this information back to the user, keeping them informed about the progress of their order. This communication loop not only enhances the user experience by providing transparency but also allows for prompt resolution of any issues that may arise during the ordering process. Overall, this operation is a critical step in ensuring that the replacement computing entity is procured efficiently and effectively, aligning with the user's needs and expectations.

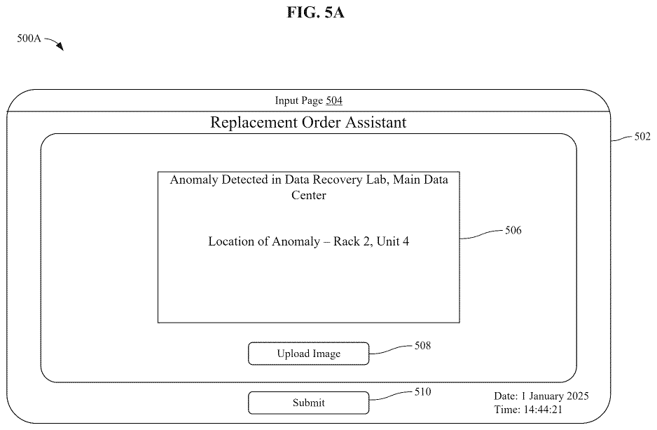

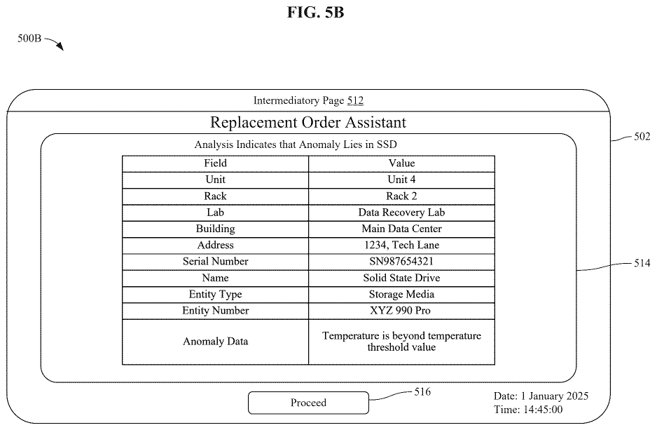

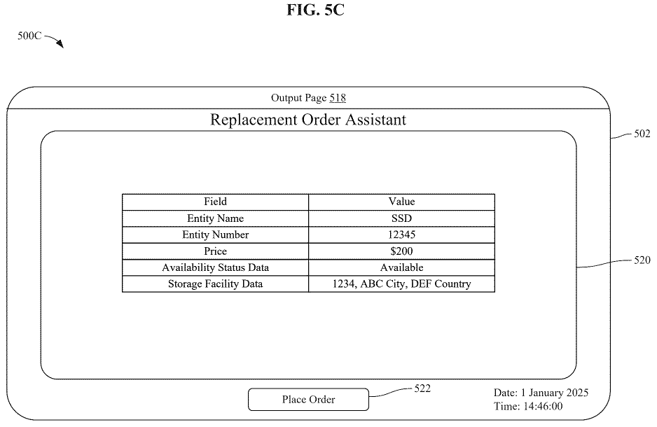

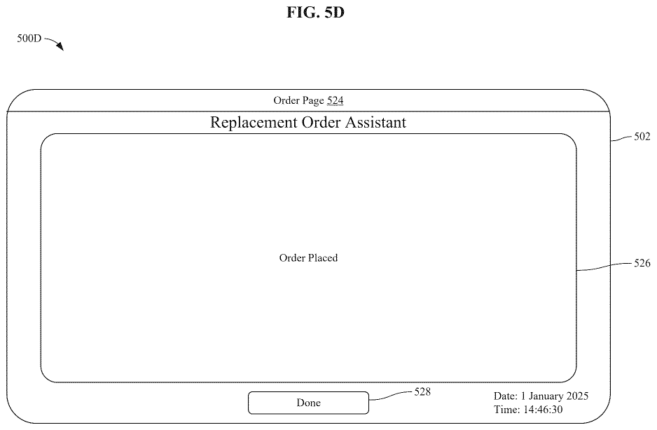

FIG. 5A is a diagram that illustrates a first exemplary User Interface (UI) 500A for the generation of the replacement entity data 202D to replace the computing entity 204, in accordance with an embodiment of the disclosure. FIG. 5A is explained in conjunction with elements of FIG. 1, FIG. 2, FIG. 3, and FIG. 4.

As shown in FIG. 5A, an input page 504 is rendered on the user device 502. The input page 504 displays a heading that may correspond to “Replacement Order Assistant”. Further, the input page 504 includes the second UI element 506. The second UI element 506 corresponds to a display unit. By way of example, and not by limitation, the system 202 is configured to display text on the display unit. The text may correspond to “Anomaly Detected In Data Recovery Lab, Main Data Center”. By way of example, and not by limitation, the system 202 is configured to display text on the display unit. The text may correspond to “Location of Anomaly—Rack 2, Unit 4”. In an embodiment, the second UI element 506 informs the user 210 about the anomaly being detected and the location where the anomaly is detected.

In an embodiment, the input page further includes a third UI element 508. The third UI element 508 corresponds to a button. The third UI element 508 may be labeled as “upload image. The input page 504 further includes a fourth UI element 510. The fourth UI element 510 may correspond to a button. The fourth UI element 510 may be labeled as “submit”. In an embodiment, the user 210 associated with user device 502 may click on the third UI element 508 to upload the captured image of the computing entity 204. Further, upon uploading the captured image, the user 210 may click on the fourth UI element 510 to submit the image to the system 202. Once the user 210 clicks on the fourth UI element 510, the system 202 receives the image data 208A associated with the computing entity 204.

FIG. 5B is a diagram that illustrates a second exemplary User Interface (UI) 500B for the generation of the replacement entity data 202D to replace the computing entity 204, in accordance with an embodiment of the disclosure. FIG. 5B is explained in conjunction with elements of FIG. 1, FIG. 2, FIG. 3, FIG. 4, and FIG. 5A.

As shown in FIG. 5B, an intermediatory page 512 is provided. In an embodiment, the intermediatory page 512 includes a first UI element 514. The first UI element 514 may correspond to a display box. The system 202 is configured to display text within the first UI element 514. In an exemplary embodiment, the text may include a result of the application of the first AI model 202A on the image data 208A and the sensor data 206A. By way of example, and not by limitation, once the system 202 applies the first AI model 202A on the image data 208A and the sensor data 206A, the system 202 determines the entity data 202C associated with the computing entity 204. For example, if the system 202 determines from the application of the first AI model 202A on the image data 208A and the sensor data 206A that the computing entity 204 corresponds to the SSD, then details present within the first UI element 514 associated with the intermediatory page 512 may correspond to details about the malfunctioned SSD obtained from the sensor data 206A. Further, the user 210 may analyze the details about the malfunctioned SSD and click on a second UI element 516 associated with the intermediatory page 512. The second UI element 516 may correspond to a button labeled as “Proceed”.

As shown in FIG. 5B, there is shown a table that provides the entity data 202C of the computing entity 204 (the SSD) within the first UI element 514. By way of example, and not by limitation, the table includes two columns. A first cell of a first column may be labeled as “Field” and a first cell of the second column may be labeled as “Value”. Further, a second cell of the first column may be labeled as “Unit”. The “Unit” may be associated with the computing entity 204. The value of the field corresponding to the “Unit” is present in a second cell of the second column. An exemplary value in the second cell of the second column may correspond to “Unit 4”. Further, a third cell of the first column may be labeled as “Rack”. In an example, the “Rack” associated with the computing entity 204 may correspond to a rack where the malfunctioned SSD is situated. The value of the field corresponding to the “Rack” is present in a third cell of the second column. An exemplary value in the third cell of the second column may correspond to “Rack 2”. Further, a fourth cell of the first column may be labeled as Lab”. Further, a fifth cell of the first column may be labeled as “Building”. Further, a sixth cell of the first column may be labeled as “Address”. By way of example, and not by limitation, the fourth cell of the first column, the fifth cell of the first column, and the sixth cell of the first column may collectively show the location of the server in which the computing entity 204 is situated. The value of the field corresponding to the fourth cell of the first column, the fifth cell of the first column, and the sixth cell are stored in a fourth cell of the second column, a fifth cell of the second column, and a sixth cell of the second column, respectively. For example, as shown in FIG. 5B, the location of the server where the malfunctioned SSD is present corresponds to “Data Discovery Lab” of “Main Data Center”, in “1234, Tech Lane”.

Further, a seventh cell of the first column may be labeled as “Name”. The seventh cell of the first column includes the name of the computing entity 204. For example, the name of the computing entity 204 corresponds to “Solid State Drive”. The value of the field corresponding to the “Name” is present in a seventh cell of the second column. Further, an eighth cell of the first column may be labeled as “Entity Type”. The eight cell may be indicative of a type of the computing entity 204. For example, the SSD is type of a storage media, so the “Entity Type” corresponds to “Storage Media”. The value of the field corresponding to the “Entity Type” is present in an eighth cell of the second column. Further, a ninth cell of the first column may be labeled as “Entity Number”. In an exemplary embodiment, “Entity Number” may be indicative of the model of the computing entity 204. As shown in FIG. 5B, the “Entity Number” of the computing entity 204 corresponds to “XYZ 990 Pro”. The value of the field corresponding to the “Entity Number” is present in a ninth cell of the second column. It may be noted that the table shown in FIG. 5B is exemplary and format of the table may be prone to change as per configurations of the system 202.

FIG. 5C is a diagram that illustrates a third exemplary User Interface (UI) 500C for the generation of the replacement entity data 202D to replace the computing entity 204, in accordance with an embodiment of the disclosure. FIG. 5C is explained in conjunction with elements of FIG. 1, FIG. 2, FIG. 3, FIG. 4, FIG. 5A, and FIG. 5B.

As shown in FIG. 5C an output page 518 is rendered. The system 202 is configured to render the output page 518 on the user device 208. The output page 518 includes a first UI element 520. The first UI element 520 may correspond to a display box. The display box may include the replacement entity data 202D. The details about the replacement entity data 202D are provided in FIG. 4. Further, the output page 518 includes a second UI element 522. The second UI element 522 corresponds to a button. The button may be labeled as “Place Order”.

By way of example, and not by limitation, the user 210 may analyze the replacement entity data 202D. Upon the analysis, the user 210 may click on the second UI element 522 to place the order for the replacement computing entity.

As shown in FIG. 5C, there is displayed a table that provides the replacement entity data 202D of the replacement computing entity (the SSD) within the first UI element 520. By way of example, and not by limitation, the table includes two columns. A first cell of a first column may be labeled as “Field” and a first cell of the second column may be labeled as “Value.” Further, a second cell of the first column may be labeled as “Entity Name.” The “Entity Name” corresponds to the type of the replacement computing entity, which corresponds to the “SSD.” The value of the field corresponding to the “Entity Name” is present in a second cell of the second column.

Further, a third cell of the first column may be labeled as “Entity Number.” In an exemplary embodiment, the “Entity Number” may indicate a unique identifier for the replacement SSD. As shown in FIG. 5C, the “Entity Number” of the replacement computing entity corresponds to “12345.” The value of the field corresponding to the “Entity Number” is present in a third cell of the second column. Additionally, a fourth cell of the first column may be labeled as “Price.” The “Price” field indicates the cost associated with the replacement SSD, which is represented in the fourth cell of the second column as “$200.”

Further, a fifth cell of the first column may be labeled as “Availability Status Data.” This field indicates the current availability of the replacement SSD. As shown in FIG. 5C, the value corresponding to the “Availability Status Data” is present in the fifth cell of the second column, which states “Available.” Further, a sixth cell of the first column may be labeled as “Storage Facility Data.” This field provides information about the location where the replacement SSD is available. The value corresponding to the “Storage Facility Data” is present in the sixth cell of the second column, indicating “1234, ABC City, DEF Country.”

FIG. 5D is a diagram that illustrates a fourth exemplary User Interface (UI) 500D for the generation of the replacement entity data 202D to replace the computing entity 204, in accordance with an embodiment of the disclosure. FIG. 5D is explained in conjunction with elements of FIG. 1, FIG. 2, FIG. 3, FIG. 4, FIG. 5A, FIG. 5B, and FIG. 5C.

As shown in FIG. 5D, the system 202 renders an order page 524. The order page 524 includes a first UI element 526. The first UI element 526 may correspond to a display box. The display box may render text once the user 210 places an order. The text may correspond to “Order Placed”. Further, the order page 524 includes a second UI element 528. The second UI element 528 may correspond to a button labeled as “Done”. The user 210 may click on the second UI element 528 to close the replacement order assistant.

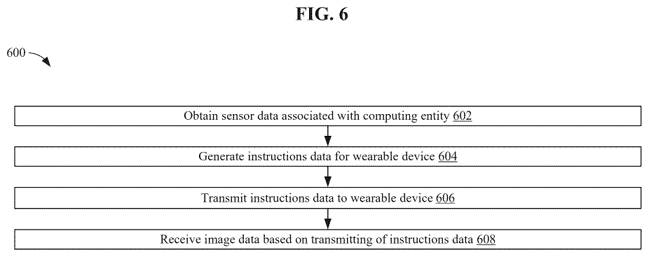

In certain cases, the system 202 may utilize augmented reality (AR) for receiving the image data 208A. Details associated with receiving the image data 208A using augmented reality are described in conjunction with, for example, FIG. 6.

FIG. 6 is a diagram that illustrates a flowchart 600 for the reception of the image data 208A based on transmission of instructions data, in accordance with an embodiment of the disclosure. FIG. 6 is explained in conjunction with elements of FIG. 1, FIG. 2, FIG. 3, FIG. 4, FIG. 5A, FIG. 5B, FIG. 5C, and FIG. 5D.

At, 602, the system 202 is configured to obtain the sensor data 206A associated with the computing entity 204. The sensor data 206A is obtained from the one or more sensors 206 associated with the computing entity 204. Further details about obtaining the sensor data 206A are provided in FIG. 3.

At 604, the system 202 is configured to generate instruction data for the wearable device associated with the user 210. In an exemplary embodiment, the system 202 generates instructions data for the wearable device upon obtaining the sensor data 206A. The wearable device is associated with the user 210. In an embodiment, the wearable device corresponds to the user device 208. In an alternate embodiment, the wearable device is different from the user device 208. By way of example, and not by limitation, the wearable device corresponds to a smartwatch that is worn by the user 210. The system 202 generates the instruction data for the wearable device. In an exemplary embodiment, the instruction data may include, but is not limited to, location of the computing entity 204 and an alert notifying the user 210 about the malfunctioning of the computing entity 204.

At 606, the system 202 is configured to transmit the instructions data to the wearable device associated with the user 210. By way of example, and not by limitation, the system 202 transmits the instructions data to the wearable device over the WAN 104. Further, the system 202 may be configured to transmit the alert on the wearable device. The alert is indicative of the anomaly associated with the computing entity 204. In an embodiment, upon receiving the transmitted alert on the wearable device and receiving the transmitted instructions data on the wearable device, the user 210 approaches the location of the detected anomaly.

At 608, the system 202 is configured to receive the image data 208A based on the transmission of the instructions data. By way of example, and not by limitation, upon reaching the location of the detected anomaly, the user 210 captures the image of the computing entity 204 on the user device 208. In an exemplary embodiment, the user device 208 may employ an Augmented Reality (AR) camera to capture the image of the computing entity 204, enhancing the accuracy of part identification. The automated identification process, operated by AI-driven image recognition, significantly reduces human error, ensuring that the correct entity number is consistently identified. Further, once the user 210 captures the image data 208A using the user device 208, the system 202 receives the image data 208A from the user device 208.

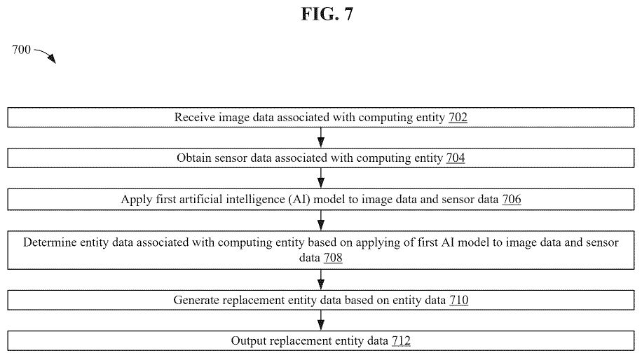

FIG. 7 illustrates a flowchart 700 of a first exemplary method for the generation of the replacement entity data 202D to replace the computing entity 204, in accordance with an embodiment of the disclosure. FIG. 6 is explained in conjunction with elements of FIG. 1, FIG. 2, FIG. 3, FIG. 4, FIG. 5A, FIG. 5B, FIG. 5C, FIG. 5D, and FIG. 6. With reference to FIG. 7, there is shown the flowchart 600. The operations of the exemplary method may be executed by any computing system, for example, by the computer 102 of FIG. 1 or the system 202 of FIG. 2. The operations of the flowchart 700 may start at 702.

At 702, the image data 208A associated with the computing entity 204 is received. In an embodiment, the system 202 is configured to receive the image data 208A associated with the computing entity 204.

At 704, the sensor data 206A associated with the computing entity 204 is obtained. The sensor data 206A is obtained from the one or more sensors 206 associated with the computing entity 204. In an embodiment, the system 202 is configured to obtain the sensor data 206A associated with the computing entity 204. The sensor data 206A is obtained from the one or more sensors 206 associated with the computing entity 204.

At 706, the first AI model 202A is applied to the image data 208A and the sensor data 206A. In an embodiment, the system 202 is configured to apply the first AI model 202A to the image data 208A and the sensor data 206A.

At 708, the entity data 202C associated with the computing entity 204 is determined based on the application of the first AI model 202A to the image data 208A and the sensor data 206A. In an embodiment, the system 202 is configured to determine the entity data 202C associated with the computing entity 204 based on the application of the first AI model 202A to the image data 208A and the sensor data 206A.

At 710, the replacement entity data 202D is generated based on the entity data 202C. The replacement entity data 202D is associated with the replacement computing entity to replace the computing entity 204. In an embodiment, the system 202 is configured to generate the replacement entity data 202D based on the entity data 202C. The replacement entity data 202D is associated with the replacement computing entity to replace the computing entity 204.

At 712, the replacement entity data 202D is outputted. In an embodiment, the system 202 is configured to output the replacement entity data 202D.

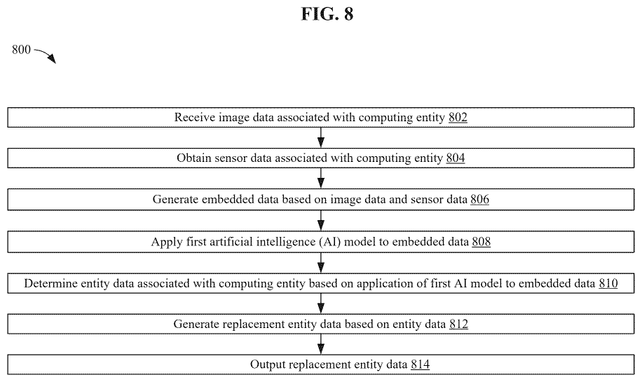

FIG. 8 illustrates a flowchart 800 of a second exemplary method for the generation of the replacement entity data 202D to replace the computing entity 204, in accordance with an embodiment of the disclosure. FIG. 8 is explained in conjunction with elements of FIG. 1, FIG. 2, FIG. 3, FIG. 4, FIG. 5A, FIG. 5B, FIG. 5C, FIG. 5D, FIG. 6, and FIG. 7. With reference to FIG. 8, there is shown the flowchart 800. The operations of the exemplary method may be executed by any computing system, for example, by the computer 102 of FIG. 1 or the system 202 of FIG. 2. The operations of the flowchart 800 may start at 802.

At 802, the image data 208A associated with the computing entity 204 is received. In an embodiment, the system 202 is configured to receive the image data 208A associated with the computing entity 204.

At 804, the sensor data 206A associated with the computing entity 204 is obtained. The sensor data 206A is obtained from the one or more sensors 206 associated with the computing entity 204. In an embodiment, the system 202 is configured to obtain the sensor data 206A associated with the computing entity 204. The sensor data 206A is obtained from the one or more sensors 206 associated with the computing entity 204.

At 806, the embedded data is generated based on the image data 208A and the sensor data 206A. In an embodiment, the system 202 is configured to generate the embedded data based on the image data 208A.

At 808, the first AI model 202A is applied to the embedded data. In an embodiment, the system 202 is configured to apply the first AI model 202A to the embedded data.

At 810, the entity data 202C associated with the computing entity 204 is determined based on the application of the first AI model 202A to the embedded data. In an embodiment, the system 202 is configured to determine the entity data 202C associated with the computing entity 204 based on the application of the first AI model 202A to the embedded data.

At 812, the replacement entity data 202D is generated based on the entity data 202C. The replacement entity data 202D is associated with the replacement computing entity to replace the computing entity 204. In an embodiment, the system 202 is configured to generate the replacement entity data 202D based on the entity data 202C. The replacement entity data 202D is associated with the replacement computing entity to replace the computing entity 204.

At 814, the replacement entity data 202D is outputted. In an embodiment, the system 202 is configured to output the replacement entity data 202D.

In various embodiments of the disclosure, a computer program product for generation of replacement entity data to replace a computing entity is described. The computer program product includes a computer-readable storage media having program instructions stored on the computer-readable storage media to perform operations. The operations include receiving image data associated with the computing entity. The operations further include obtaining sensor data associated with the computing entity. The sensor data is obtained from one or more sensors associated with the computing entity. The operations further include applying an artificial intelligence (AI) model to the image data and the sensor data. The operations further include determining entity data associated with the computing entity based on the application of the AI model to the image data and the sensor data. The operations further include generating replacement entity data based on the entity data. The replacement entity data is associated with a replacement computing entity to replace the computing entity. The operations further include outputting the replacement entity data.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
receiving, by a computer, image data associated with a computing entity;
obtaining, by the computer, sensor data associated with the computing entity, wherein
the sensor data is obtained from one or more sensors associated with the computing entity, and
the sensor data indicates a hardware malfunction of the computing entity;
performing, by the computer, a resizing operation and a normalization operation on the image data;
converting, by the computer, based on the performing of the resizing operation and the normalization operation, the image data into vector representations of the image data;
embedding, by the computer, the vector representations of the image data with the sensor data to generate embedded data;
training, by the computer, a first artificial intelligence (AI) model for recognizing and differentiating between different computing entities, wherein the different computing entities include the computing entity;
applying, by the computer, the first AI model to the embedded data;
determining, by the computer, entity data associated with the computing entity based on the applying of the first AI model to the embedded data;
generating, by the computer, replacement entity data based on the entity data, wherein the replacement entity data is associated with a replacement computing entity of the different computing entities to replace the computing entity; and
outputting, by the computer, the replacement entity data.

2. (canceled)

3. The computer-implemented method of claim 1, further comprising:
applying, by the computer, a second AI model to the replacement entity data;
generating, by the computer, replacement request data associated with a replacement request for the computing entity, wherein the replacement request data is generated based on the applying of the second AI model to the replacement entity data; and
outputting, by the computer, the replacement request data.

4. The computer-implemented method of claim 3, further comprising:
transmitting, by the computer, the replacement request data to a user device associated with a user;
receiving, by the computer, validation data associated with the replacement request, wherein the validation data is received based on the transmitting of the replacement request data;
validating, by the computer, the replacement request based on the validation data; and
transmitting, by the computer, replacement order data to an ordering server based on the validating of the replacement request.

5. The computer-implemented method of claim 4, further comprising:
generating, by the computer, instructions data for a wearable device, wherein the wearable device is associated with the user;
transmitting, by the computer, the instructions data to the wearable device; and
receiving, by the computer, the image data based on the transmitting of the instructions data.

6. The computer-implemented method of claim 1, further comprising:
receiving, by the computer, criterion data indicating a set of selection criterion for a selection of the replacement computing entity; and
generating, by the computer, the replacement entity data based on the criterion data.

7. The computer-implemented method of claim 1, wherein the sensor data indicates contextual hardware information associated with at least one of the computing entity, or a device comprising the computing entity.

8. The computer-implemented method of claim 7, wherein the sensor data is selected from the group consisting of time data associated with the obtaining of the sensor data, client data associated with a client using the computing entity, anomaly data for an anomaly associated with the computing entity, device data associated with the device comprising the computing entity, and status data associated with the device.

9. The computer-implemented method of claim 1, wherein the replacement entity data is selected from the group consisting of an entity name associated with the replacement computing entity, an entity number associated with the replacement computing entity, a price associated with the replacement computing entity, availability status data associated with the replacement computing entity, and storage facility data associated with one or more storage facilities storing the replacement computing entity.

10. The computer-implemented method of claim 1, wherein the entity data is selected from the group consisting of a serial number associated with the computing entity, a unit number associated with the computing entity, a name associated with the computing entity, location data associated with the computing entity, an entity type associated with the computing entity, and an entity number associated with the computing entity.

11. The computer-implemented method of claim 1, further comprising:
validating, by the computer, the replacement entity data based on the image data; and
outputting, by the computer, the replacement entity data based on the validating of the replacement entity data.

12. The computer-implemented method of claim 1, wherein the computing entity corresponds to a data center component.

13. A computer system, comprising:
a processor set;
one or more computer-readable storage media; and
program instructions stored on the one or more computer-readable storage media, the program instructions executable by the processor set to cause the processor set to:
receive image data associated with a computing entity;
obtain sensor data associated with the computing entity, wherein
the sensor data is obtained from one or more sensors associated with the computing entity, and
the sensor data indicates a hardware malfunction of the computing entity;
perform a resizing operation and a normalization operation on the image data;
convert, based on the resizing operation and the normalization operation, the image data into vector representations of the image data;
embed the vector representations of the image data with the sensor data to generate embedded data;
train a first artificial intelligence (AI) model to recognize and differentiate between different computing entities, wherein the different computing entities include the computing entity;
apply the first AI model to the embedded data;
determine entity data associated with the computing entity based on the application of the first AI model to the embedded data;
generate replacement entity data based on the entity data, wherein the replacement entity data is associated with a replacement computing entity of the different computing entities to replace the computing entity; and
output the replacement entity data.

14. The computer system of claim 13, wherein the program instructions further cause the processor set to:
apply a second AI model to the replacement entity data;
generate replacement request data associated with a replacement request for the computing entity, wherein the replacement request data is generated based on the application of the second AI model to the replacement entity data; and
output the replacement request data.

15. The computer system of claim 14, wherein the program instructions further cause the processor set to:
transmit the replacement request data to a user device associated with a user;
receive validation data associated with the replacement request, wherein the validation data is received based on the transmission of the replacement request data;
validate the replacement request based on the validation data; and
transmit replacement order data to an ordering server based on the validation of the replacement request.

16. The computer system of claim 15, wherein the program instructions further cause the processor set to:
generate instructions data for a wearable device, wherein the wearable device is associated with the user;
transmit the instructions data to the wearable device; and
receive the image data based on the transmission of the instructions data.

17. The computer system of claim 13, wherein the program instructions further cause the processor set to:
receive criterion data that indicates a set of selection criterion for a selection of the replacement computing entity; and
generate the replacement entity data based on the criterion data.

18. The computer system of claim 13, wherein the sensor data indicates contextual hardware information associated with at least one of the computing entity, or a device comprising the computing entity.

19. The computer system of claim 13, wherein the program instructions further cause the processor set to:
validate the replacement entity data based on the image data; and
output the replacement entity data based on the validation of the replacement entity data.

20. A computer-program product for generation of replacement entity data to replace a computing entity, the computer-program product comprising:
one or more computer-readable storage media; and
program instructions stored on the one or more computer-readable storage media to perform operations comprising:
receiving image data associated with the computing entity;
obtaining sensor data associated with the computing entity, wherein
the sensor data is obtained from one or more sensors associated with the computing entity, and
the sensor data indicates a hardware malfunction of the computing entity;
performing a resizing operation and a normalization operation on the image data;
converting, based on the performing of the resizing operation and the normalization operation, the image data into vector representations of the image data;
embedding the vector representations of the image data with the sensor data to generate embedded data;
training a first artificial intelligence (AI) model for recognizing and differentiating between different computing entities, wherein the different computing entities include the computing entity;
applying the first AI model to the embedded data;
determining entity data associated with the computing entity based on the applying of the first AI model to the embedded data;
generating the replacement entity data based on the entity data, wherein the replacement entity data is associated with a replacement computing entity of the different computing entities to replace the computing entity; and
outputting the replacement entity data.
